(19) United States
(12) Patent Application Publication
(10) Pub. No.: US 2025/0256789 A1
(43) Pub. Date: Aug. 14, 2025

(54) PLENUM SKIRTING FOR POWERED DOWNFORCE

(71) Applicant: FCA US LLC, Auburn Hills, MI (US)

(72) Inventors: Mark E Stout, Auburn Hills, MI (US); Travis D Bechtel, Goodrich, MI (US); Brandon F Brady, Lapeer, MI (US); Zachary A Luetzen, West Bloomfield, MI (US)

(21) Appl. No.: 18/441,139

(22) Filed: Feb. 14, 2024

(51) Int. Cl. B62D 35/00; B60R 16/08

(52) U.S. Cl. CPC B62D 35/008; B60R 16/08

(57) ABSTRACT

A vehicle plenum skirt has an inflatable skirt that extends downward from an underside of a vehicle toward the ground. A plurality of limiting actuators maintain a gap between the vehicle underside and a road surface.

### FIELD

The present disclosure relates to vehicles and, more particularly, to vehicles with an underbody skirt that provides a plenum that creates a low pressure or vacuum under the vehicle that pushes the car towards the ground to improve tire adhesion.

### BACKGROUND

This section provides background information related to the present disclosure which is not necessarily prior art.

The acceleration, braking and cornering capabilities of ultra-high performance electric vehicles are limited by the amount of tractive force the vehicles can impart on the road surface they are drive on. Advances in electric vehicle motors and battery technology have driven the 0-60 mph acceleration time of many well-publicized vehicles below the 1.5 second mark on prepared surfaces. Such acceleration goes beyond what most tires are capable of handling, requiring additional downward force to be generated that supplements the force of gravity in keeping the vehicle firmly planted on the ground.

One method of generating this downward force is to create a low-pressure region underneath the car that causes the car to be sucked down toward the ground. The airflow required to maintain this region of low pressure may be generated by any additional device that can create a lower pressure than the ambient atmosphere of the vehicle. The airflow through this low-pressure region must be carefully controlled, as an inlet leak path will reduce the downward force on the vehicle leading to a lack of tire adhesion. Also, no airflow creates a sealed condition that prevents the vehicle drive wheels from moving the vehicle efficiently. The consistency of the created downward force is also critical to the geometry of the vehicle suspension system and its proper tuning, as the amount of force generated affects the ride height of the vehicle relative to the ground. Thus, the size of an air gap or restriction between the low-pressure region and road surface must be carefully maintained through several dynamic driving situations, including undulations in the road surface and loading of the vehicle suspension. The vehicle's suspension may be actively controlled, presenting a change in the way the vehicle body responds to these driving situations as compared with traditional suspension systems.

Various types of race cars have utilized rigid skirts with large fans underneath the vehicle to create a low pressure region to force the vehicle toward the ground. The rigid skirt panels around the outside body panels of the vehicle were tied with the suspension to attempt to maintain a constant distant from the ground. These skirts are not adjustable to provide a constant distance or gap with the ground. Further, the skirts are susceptible to impact with curbs or the like which subjects them to turning or braking conditions. These designs are specific for race cars and not intended for road use.

In accordance with the present disclosure, a controlled skirt extends downward from an underside of the vehicle. The skirt is controlled to maintain a precise gap between the low-pressure region under the vehicle and the road surface. By evacuating air from this region and restricting the flow of back air, via control of this air gap, creates a zone of low pressure that pushes the car toward the ground to improve tire adhesion. The skirt has a closed shape to provide these characteristics.

The skirt maintains the gap between a variety of high performance driving situations as the vehicle suspension articulates and the vehicle body moves relative to the road surface. The vehicle suspension may be actively controlled in which case the movement of the vehicle suspension and the gap between the skirt and the road surface must be closely tied.

Additionally, the present disclosure enables lifting or retracting of the skirt system when the vehicle operates at high speeds where forward vehicle speed is able to generate downward force on the tires via wings or purposely shaped body panel geometry. It is desirable to retract the skirt at low speeds when the downforce is not needed, such as normal street driving conditions, in order to prevent damage to the system. The ability to retract the skirt to provide additional ground clearance may be augmented by an active suspension system that can further raise the vehicle to clear larger obstacles such as speed bumps, approaches or trailer loading ramps.

### SUMMARY

This section provides a general summary of the disclosure, and is not a comprehensive disclosure of its full scope or all of its features.

According to a first aspect of the disclosure, a vehicle plenum skirt comprises an inflatable skirt that extends downward from an underside of a vehicle toward the ground. A plurality of limiting actuators maintains a gap between the vehicle underside, the skirt and a road surface. A compressor is utilized to inflate the skirt. The compressor is coupled with an inlet of the skirt and an outlet in the skirt enables airflow to exit the skirt. The skirt has a closed configuration shape, such as an oval, rectangle, pentagon or hexagon or the like. A wear element is secured to the skirt for road contact. A controller is coupled with the actuators to force collapse the skirt to maintain a gap between the skirt and the ground. The controller includes on board vehicle accelerometers, suspension travel sensors and wheel speed sensors. The inflatable skirt includes a bellows portion.

According to a second aspect of the disclosure, a vehicle with a plenum skirt comprises a vehicle with wheels and an underbody. The vehicle plenum skirt includes an inflatable skirt that extends downward from the underside of the vehicle toward the ground. A plurality of limiting actuators maintains a gap between the vehicle underside, the skirt and a road surface. A compressor is utilized to inflate the skirt. The compressor is coupled with an inlet of the skirt and an outlet in the skirt that enables airflow to exit the skirt. The skirt has a closed configuration shape, such as an oval, rectangle, pentagon or hexagon or the like. A wear element is secured to the skirt for road contact. A controller is coupled with the actuators to force collapse the skirt to maintain a gap between the skirt and the ground. The controller includes on board vehicle accelerometers, suspension travel sensors and wheel speed sensors. The inflatable skirt includes a bellows portion.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a vehicle in accordance with the present disclosure.

FIG. 2 is a schematic view of a plenum skirt in accordance with the disclosure.

FIG. 3 is a schematic view of a plenum layout.

FIG. 4 is another schematic view of a plenum layout.

FIG. 5 is an additional view of a plenum layout.

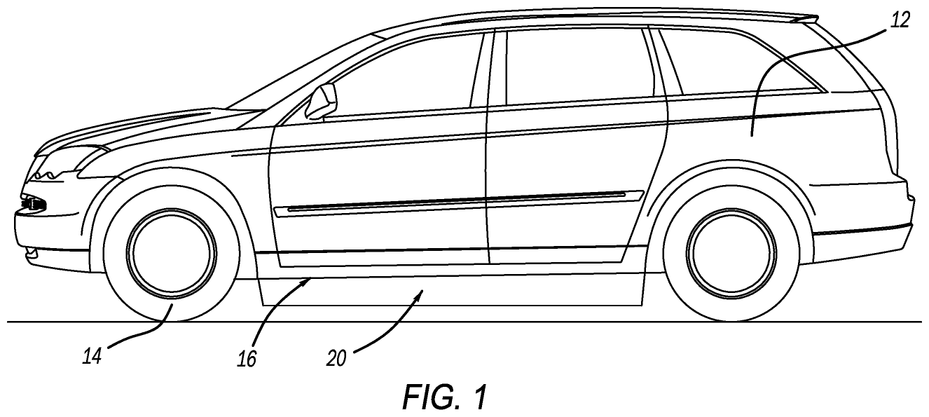

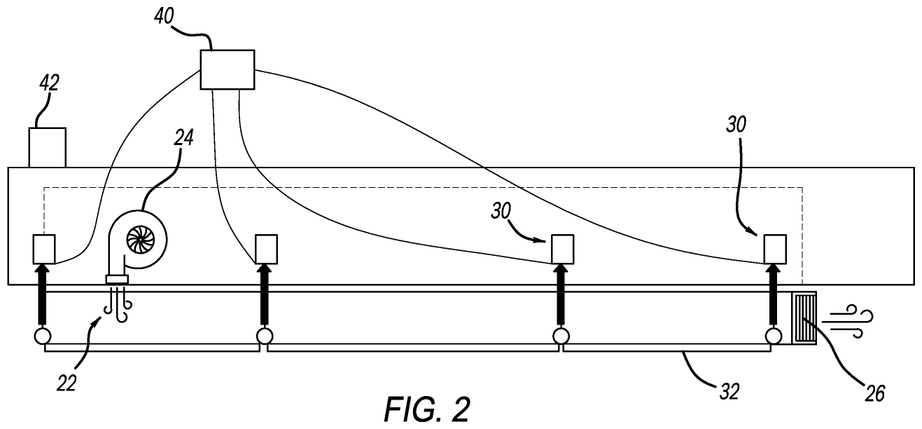

Corresponding reference numerals indicate corresponding parts throughout the several views of the drawings.

### DETAILED DESCRIPTION

Example embodiments will now be described more fully with reference to the accompanying drawings.

Turning to the figures, a vehicle is illustrated and designated with the reference numeral 10. The vehicle 10 includes a body 12 supported by wheels 14. The body 12 includes an underside 16 that includes a skirting system 20.

The skirt system 20 includes a pneumatically inflated skirt 22 that extends downward from the underside 16 of the vehicle 10 to maintain a precise gap between the low pressure region inside of the skirt, under the vehicle and the road surface. As air is evacuated from this region, the skirt 22 restricts the flow of air back into the closed region and creates a zone of low pressure in the region that pushes the car towards the ground. This enables the ground force to the tires to exceed the proportional mass distribution of the vehicle due to gravity alone.

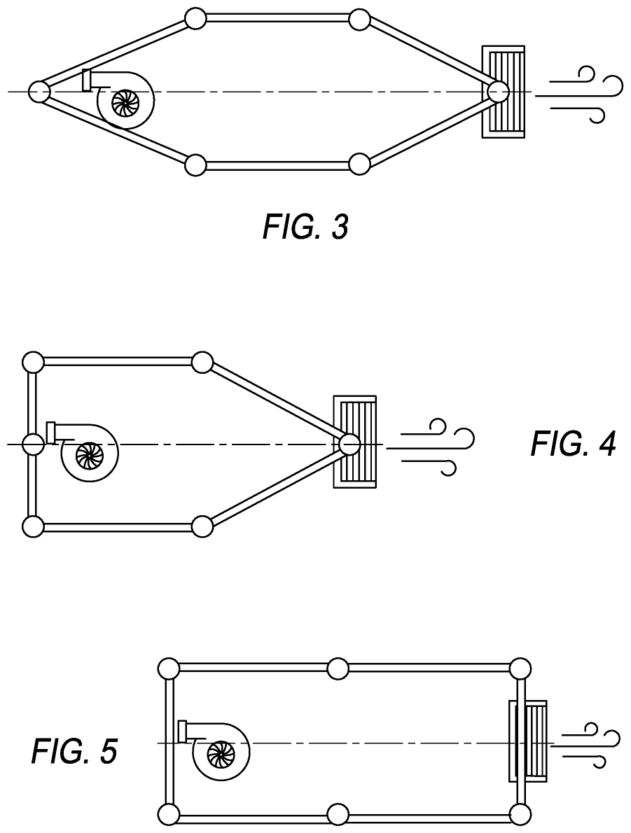

A flow inductor or compressor 24 enables airflow into the skirt 22 and creates sufficient internal pressure to inflate the skirt 22. The skirt 22 includes a vent 26 to enable exhaustion of the air within the skirt 22 at a rapid rate that enables the skirt 22 to change shape to follow the road surface and prevent damage in the event of impact with a bump or debris. The skirt 22 has a closed configuration as illustrated in FIGS. 3-5. The skirt may have an oval, rectangle, pentagonal, hexagonal or the like configuration. Just a few of the closed configurations are illustrated in FIGS. 3-5.

Actuators 30 are connected along various points of the skirt 22. The actuators 30 are vertically retracting and extending actuators and are positioned along various points of the skirt 22. The actuators 30 enable the skirt 22 to be fully collapsed globally to maintain a nominal gap with the road surface through a variety of vehicle conditions, including drive, squat and roll. The actuators 30 located near the middle of the wheel base enable the skirt 22 to conform to small annulations in the road surface during breakover conditions, or when the vehicle travels over a curb.

The skirt 22 may also be fully collapsible when the downward force is not required to be used on the road surface conditions require more ground surface. The bottom of the skirt 22 is connected to a semi-rigid conformable wear element 32 that is robust to occasionally contact with the road surface. The inflatable skirt 22 includes a bellows type skirt with multiple control points that include the vertical actuators 30.

A controller 40 controls the extension and retraction of the vertical actuators 30. The controller 40 includes a combination of onboard vehicle accelerometers 42 that measure pitch and roll of the vehicle. Also, the controller 40 includes suspension travel sensors 44 that monitor the articulation of individual wheels. Additionally, the controller 40 includes wheel speed sensors 46 that measure speed and travel distance of the vehicle.

The controller 40 is able to lift or retract the skirt system 20 when the vehicle operates at high speeds where forward vehicle speed is able to generate downward force on the tires via wings or purposely shaped body panel geometry. Also, the controller 40 is able to retract the skirt system 20 at low speeds when the downward force is not needed, such as normal street driving conditions in order to prevent damage to the skirt system 20. The ability of the controller 40 to retract or provide additional ground clearance may be augmented by an active suspension system that can further raise the vehicle to clear larger obstacles, such as speed bumps, approaches or trailer loading ramps.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle plenum skirt comprising:
an inflatable skirt that extends downward from an underside of a vehicle toward the ground; and
a plurality of limiting actuators to maintain a gap between the vehicle underside and a road surface.

2. The vehicle plenum skirt of claim 1, further comprising a compressor for inflating the skirt.

3. The vehicle plenum skirt of claim 1, further comprising an inlet and outlet in the skirt for enabling air to flow in the skirt.

4. The vehicle plenum skirt of claim 1, wherein the skirt has a closed shape, such as an oval, rectangle, pentagon or hexagon.

5. The vehicle plenum skirt of claim 1, further comprising a wear element secured to the skirt for road contact.

6. The vehicle plenum skirt of claim 1, further comprising a controller coupled with the actuators for force collapsing the skirt for maintaining the gap.

7. The vehicle plenum skirt of claim 6, wherein the controller includes on board vehicle accelerometers, suspension travel sensors and wheel speed sensors.

8. The vehicle plenum skirt of claim 1, wherein the inflatable skirt includes a bellows portion.

9. A vehicle with a plenum skirt comprising:
a vehicle having wheels and an underbody;
an inflatable skirt extending downward from the underside of the vehicle toward the ground; and
a plurality of limiting actuators to maintain a gap between the vehicle underside and a road surface.

10. The vehicle of claim 9, further comprising a compressor for inflating the skirt.

11. The vehicle of claim 9, further comprising an inlet and outlet in the skirt for enabling air to flow in the skirt.

12. The vehicle of claim 9, wherein the skirt has a closed shape, such as an oval, rectangle, pentagon or hexagon.

13. The vehicle of claim 9, further comprising a wear element secured to the skirt for road contact.

14. The vehicle of claim 9, further comprising a controller coupled with the actuators for force collapsing the skirt for maintaining the gap.

15. The vehicle of claim 14, wherein the controller includes on board vehicle accelerometers, suspension travel sensors and wheel speed sensors.

16. The vehicle of claim 9, wherein the inflatable skirt includes a bellows portion.
